(19) United States
(12) Patent Application Publication
(10) Pub. No.: US 2006/0022422 A1
(43) Pub. Date: Feb. 2, 2006

(54) TRIKE SWINGER

(76) Inventor: Gerald W. Tasma, Cedar Springs, MI (US)

Correspondence Address: MCGARRY BAIR PC, 171 MONROE AVENUE, N.W., SUITE 600, GRAND RAPIDS, MI, 49503, US

(21) Appl. No.: 11/161,319

(22) Filed: Jul. 29, 2005

Related U.S. Application Data
(60) Provisional application No. 60/521,978, filed on Jul. 29, 2004.

(51) Int. Cl. B60G 3/20

(52) U.S. Cl. 280/124.135

(57) ABSTRACT

A three wheeled vehicle comprises a frame with a rear axle assembly that mounts a pair of spaced rear wheels. The rear axle assembly includes a rear axle, a caster arm disposed at opposite ends of the rear axle and defining a caster axis, and trailing arm assemblies that couple the rear wheels to the caster arms. The caster arms are outwardly and rearwardly inclined at a camber angle and a caster angle, respectively. The trailing arm assemblies position the rear wheels such that they contact the ground surface at a point offset from an intersection of the caster axis with the ground surface. As a result of this configuration, the vehicle can swing or spinout along an arcuate path and simultaneously tilt when a rider quickly turns.

### CROSS-REFERENCE TO RELATED APPLICATION

This application claims priority to U.S. Application No. 60/521,978 filed Jul. 29, 2004.

### FIELD OF THE INVENTION

The invention relates to a three wheeled vehicle. In one of its aspects, the invention relates to a manually powered three wheeled vehicle. In another of its aspects, the invention relates to a powered three wheeled vehicle. In another of its aspects, the invention relates to a stable three wheeled vehicle that is adapted for swinging the through an arcuate path without tipping over. In yet another of its aspects, the invention relates to a three wheeled vehicle that tilts into a turn as the vehicle turns through the arcuate path.

### DESCRIPTION OF THE RELATED ART

Three wheeled vehicles, commonly known as tricycles, comprise a front wheel and a pair of spaced rear wheels, and many types and styles of tricycles have been developed for use by both children and adults. Some tricycles comprise swivel or caster rear wheels to facilitate turning or to simulate a spinout motion when the rider quickly turns the vehicle. Examples of such prior art vehicles include those disclosed in U.S. Pat. Nos. to 4,403,673 to Ball (Ball '673), 4,272,095 to Ptaszek (Ptaszek '095), and 4,327,929 to Melzian (Melzian '929).

Ball '673 discloses a powered vehicle comprising a front wheel coupled to a steering handle and a pair of two swivel rear casters. The casters include a mechanism for controlling the degree to which the casters can swivel. When the casters are in a free position, the vehicle is able to swivel and move in all directions, including sideways. When the casters are in an intermediate position, the rear of the vehicle can swing out, which simulates a skidding effect without tipping.

Ptaszek '095 discloses a riding toy having a pedal-driven front wheel and a pair of rear casters. The casters are mounted to a cross member that supports a back rest. The cross member is pivotally mounted to a frame such that when a rider leans back against the back rest, the cross member pivots relative to the frame. Consequently, the casters move between two positions: a first position wherein the casters are rearwardly angled and a second position wherein the casters are generally vertical. In the first position, the casters tend to remain straight during movement of the toy. However, in the second position, the casters can swivel such that the toy can spinout wherein the toy spins about the surface engagement point of the front wheel.

Melzian '929 discloses a tricycle comprising a pedal-driven front wheel and rear wheels in rearwardly angled caster mounts. Because of the caster mounted rear wheels, the tricycle can be turned very quickly into a 360-degree turn by a slight turn of the handlebars. The tricycle remains in an upright position even when substantial turns are rapidly made.

While these three wheeled vehicles are designed for swinging or spinout motion, they are not designed for use at both slow and fast speeds and do not significantly tilt when spinning, which can add to the amusement of the rider when operating the vehicle. Further, the rotational velocity of the vehicles is limited by the type of casters used at the rear of the vehicle.

### SUMMARY OF THE INVENTION

A vehicle according to one embodiment of the invention comprises a frame having a front portion and a rear portion; a steerable front wheel mounted to the front portion of the frame; a rear axle transverse to a longitudinal axis of the frame; a caster arm rotatably mounted at each end of the rear axle for rotation about an upright caster axis coincident with the caster arm; and a rear wheel rotatably mounted to each caster arm for rotation about an axis perpendicular to the caster axis, the rear wheel adapted to contact the ground surface at a point offset from an intersection of the caster axis with the ground surface; wherein the caster axis is positioned at a negative camber angle relative to a vertical axis.

In one embodiment of the invention, the camber angle can be in a range of about 10 degrees to about 25 degrees. The camber angle can be in a range of about 15 degrees to about 20 degrees.

In another embodiment of the invention, the rear wheel has a radial plane passing through the center of the rear wheel, and the radial plane can be offset from the caster axis. The radial plane can be outwardly offset. The radial plane can be offset from the caster axis by a distance in the range of about 0.1 to 2 inches. According to one embodiment, the radial plane is offset from the caster axis by about 0.5 inches.

In one embodiment, the caster axis has a positive caster angle with respect to a vertical axis. The caster angle of the caster axis can be selectively adjustable. The caster angle can be in a range of about 2 degrees to about 25 degrees. The caster angle can be in a range of about 10 degrees to about 15 degrees.

In another embodiment, the rear wheel can be mounted to the caster arm through an adjustable connection for raising and lowering the rear portion of the frame with respect to the rear wheel.

In one embodiment, the vehicle further comprises a brake to lock the caster arm in a variety of selected positions with respect to the rear axle. In another embodiment, the vehicle further comprises a steering rod mounted to one of the caster arms to manually control the position of the caster arm with respect to the rear axle.

Further according to the invention, the vehicle can further comprise a seat adjustably mounted to the frame. The vehicle can further comprise a steering mechanism mounted to the frame between the front wheel and the seat. The steering mechanism can be adjustably mounted to the frame.

In yet another embodiment, the vehicle can further comprise a motor mounted to the frame and operably connected to the front wheel for driving the front wheel.

A vehicle according to another embodiment of the invention comprises a frame having a front portion and a rear portion; a steerable front wheel mounted to the front portion of the frame; a rear axle transverse to a longitudinal axis of the frame; a caster arm rotatably mounted at each end of the rear axle for rotation about an upright caster axis coincident with the caster arm; and a rear wheel rotatably mounted to each caster arm for rotation about an axis perpendicular to the caster axis, the rear wheel adapted to contact the ground surface at a point offset from an intersection of the caster axis with the ground surface; wherein the rear wheel has a radial plane passing through the center of the rear wheel, and the radial plane is offset from the caster axis.

In one embodiment, the radial plane is outwardly offset. The radial plane can be offset from the caster axis by a distance in the range of about 0.1 to 2 inches. The radial plane can be offset from the caster axis by about 0.5 inches.

A vehicle according to another embodiment of the invention comprises a frame having a front portion and a rear portion; a steerable front wheel mounted to the front portion of the frame; a rear axle transverse to a longitudinal axis of the frame; a caster arm rotatably mounted at each end of the rear axle for rotation about an upright caster axis coincident with the caster arm; and a rear wheel rotatably mounted to each caster arm for rotation about an axis perpendicular to the caster axis, the rear wheel adapted to contact the ground surface at a point offset from an intersection of the caster axis with the ground surface; wherein the rear wheel is mounted to the caster arm through an adjustable connection for raising and lowering the rear portion of the frame with respect to the rear wheel.

In yet another embodiment, a vehicle according to the invention comprises a frame having a front portion and a rear portion; a steerable front wheel mounted to the front portion of the frame; a rear axle transverse to a longitudinal axis of the frame; a caster arm rotatably mounted at each end of the rear axle for rotation about an upright caster axis coincident with the caster arm; a rear wheel rotatably mounted to each caster arm for rotation about an axis perpendicular to the caster axis, the rear wheel adapted to contact the ground surface at a point offset from an intersection of the caster axis with the ground surface; and a steering rod mounted to one of the caster arms to manually control the position of the caster arm with respect to the rear axle.

In yet another embodiment, a vehicle according to the invention comprises a frame having a front portion and a rear portion; a steerable front wheel mounted to the front portion of the frame; a rear axle transverse to a longitudinal axis of the frame; a caster arm rotatably mounted at each end of the rear axle for rotation about an upright caster axis coincident with the caster arm; and a rear wheel rotatably mounted to each caster arm for rotation about an axis perpendicular to the caster axis, the rear wheel adapted to contact the ground surface at a point offset from an intersection of the caster axis with the ground surface; wherein the caster axis has a positive caster angle with respect to a vertical axis, and the caster angle of the caster axis is selectively adjustable.

### BRIEF DESCRIPTION OF THE DRAWINGS

FIG. 1 is a rear perspective view of a three wheeled vehicle according to the invention.

FIG. 2 is a front view of the vehicle shown in FIG. 1.

FIG. 3 is a rear view of the vehicle shown in FIG. 1.

FIG. 4 is a front perspective view of the vehicle shown in FIG. 1.

FIG. 5 is a schematic rear view of a portion of a rear axle assembly from the vehicle shown in FIG. 1

FIG. 6 is a schematic top view of a portion of the rear axle assembly from the vehicle shown in FIG. 1.

FIG. 7 is a schematic side view of a portion of the rear axle assembly from the vehicle shown in FIG. 1.

FIG. 8 is a schematic perspective view of a caster arm of the rear axle assembly from the vehicle shown in FIG. 1 and a plane perpendicular to the caster arm.

FIG. 9 is a rear perspective view of the vehicle shown in FIG. 1 turning to the left.

FIG. 10 is a rear perspective view of the vehicle shown in FIG. 1 turning to the right.

FIG. 11 is a front perspective view of an alternative embodiment of a three wheeled vehicle according to the invention.

FIG. 12 is a front view of the vehicle shown in FIG. 11.

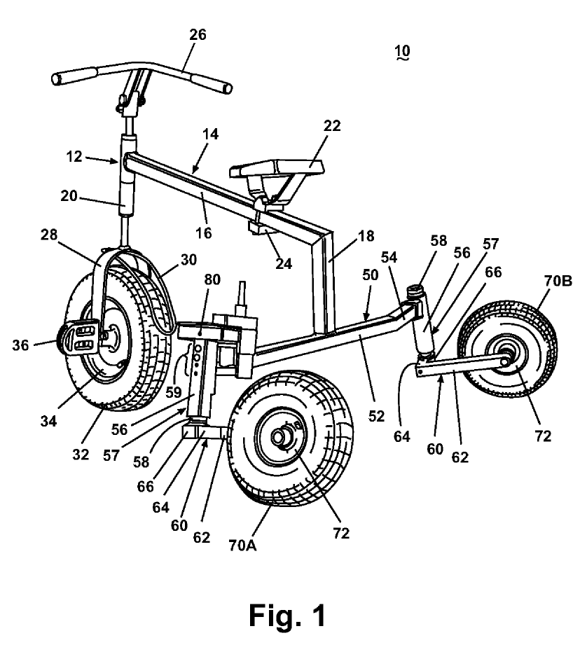

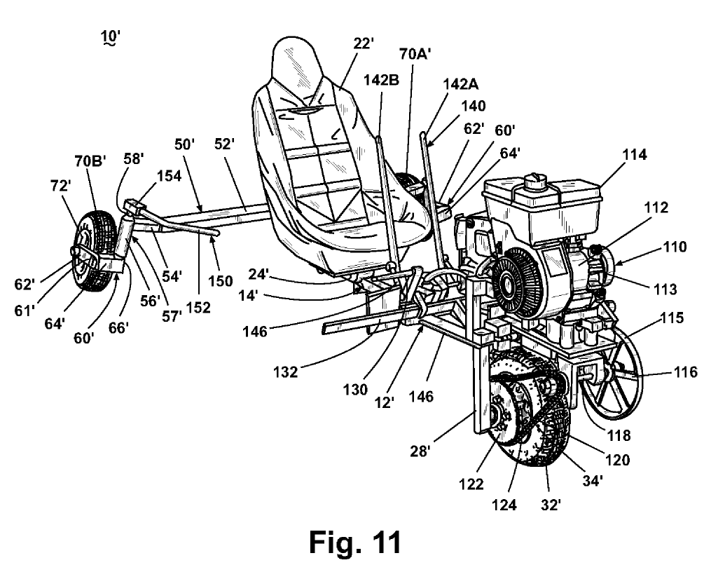

FIG. 1 3 is a side view of the vehicle shown in FIG. 11.

FIG. 14 is a rear view of the vehicle shown in FIG. 11.

FIG. 15 is a side perspective view of a rear axle assembly from the vehicle shown in FIG. 11.

FIG. 16 is a rear perspective view of a portion of the rear axle assembly from the vehicle shown in FIG. 11.

FIG. 17 is a schematic top view of a portion of the rear axle assembly from the vehicle shown in FIG. 11.

FIG. 18 is a rear view of the vehicle shown in FIG. 11 turning to the left.

FIG. 19 is a rear view of the vehicle shown in FIG. 11 turning to the right.

### DESCRIPTION OF THE PREFERRED EMBODIMENT

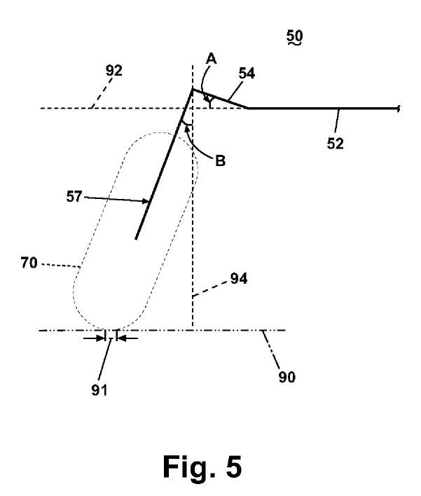

Referring now to the drawings and particularly to FIGS. 1-4, a three wheeled vehicle 10 according to the invention comprises a frame 12 having a center frame 14, a steering tube 20 at a front portion of the frame 12 and mounted to one end of the center frame 14, and a rear axle assembly 50 at a rear portion of the frame 12 and mounted to an opposite end of the center frame 14. The center frame 14, which defines a longitudinal axis of the vehicle 10, is generally L-shaped and comprises a center bar 16 that is slightly inclined relative to a horizontal plane and a connecting bar 18 depending from the center bar 16 and slightly inclined relative to a vertical plane. The center bar 16 slidingly mounts a seat 22 through an adjustable seat bracket 24 that receives the center bar 16. The steering tube 20 is fixedly connected to the center frame 14 at the center bar 16 and supports a handle bar assembly 26 at an upper portion thereof and a wheel fork 28 at a lower portion thereof. The handle bar assembly 26 and the wheel fork 28 are in operative communication with each another such that rotation of the handle bar assembly 26 induces rotation of the wheel fork 28, as is well-known in the three wheeled vehicle art. Preferably, the steering tube 20 is angled slightly rearward (about 1-degree) relative to a vertical axis (not shown). A curved front wheel 32 (i.e., a wheel having a curved ground contact profile as compared to a wheel having a flat ground contact profile for use on a conventional automobile) with a central hub 34 is rotatably mounted to the wheel fork 28 and partially supports the vehicle 10 on a ground surface 90 (FIG. 5). The front wheel 32 can be driven by rotation of a pair of pedals 36 mounted to the wheel fork 28 and on both sides of the front wheel 32 in a conventional fashion. The wheel fork 28 further includes a fender 30 secured thereto and covering an upper portion of the front wheel 32 to prevent a rider from inadvertently contacting the front wheel 32.

The rear axle assembly 50, which is mounted transverse to the center frame 14 at the connecting bar 18, comprises a horizontal rear axle 52 with inclined end portions 54 and a pair of depending caster arms 57 mounted to the inclined end portions 54 of the rear axle 52. The caster arms 57 each comprise a tubular shaft 56 with a series of adjustment holes 59 and an internal rotatable member 58 within the shaft 56 and rotatable relative to the shaft 56 about a caster axis coincident with the longitudinal axis of the caster arm 57. The caster arms 57 are attached to trailing arm assemblies 60 that pivotally couple the internal rotatable member 58 to curved rear wheels 70 (a first rear wheel 70A and a second rear wheel 70B) that partially support the vehicle 10 on the ground surface 90.

The caster arms 57 are preferably mounted to the rear axle 52 with mechanical fasteners (not shown), such as bolts, that are accessible through the adjustment holes 59. By loosening the mechanical fasteners, the position of the caster arms 57 relative to the rear axle 52 can be adjusted to a desired position. Once the desired position is achieved, the mechanical fasteners are tightened to secure the caster arms 57 in place. It is within the scope of the invention for the vehicle 10 to comprise other mechanisms for adjustably mounting the caster arms 57 to the rear axle 52.

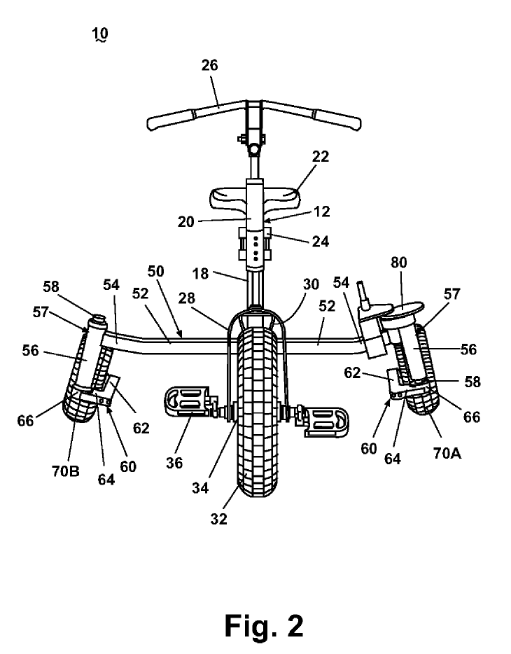

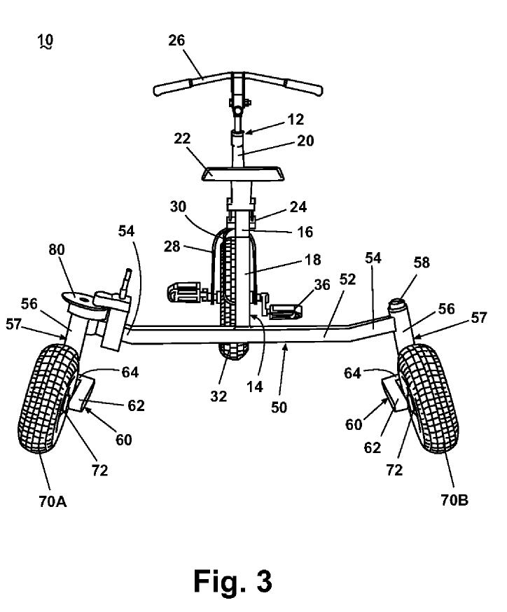

As best seen in FIGS. 2 and 3 and shown schematically in FIG. 5, which is a rear view of a portion of the rear axle assembly 50, the inclined end portions 54 of the rear axle 52 are inclined relative to the rear axle 52 and to a horizontal axis 92 at an angle A. The caster arms 57 are substantially perpendicular to the inclined end portions 54 of the rear axle 52. Hence, the caster arms 57 are inclined relative to a vertical axis 94 at an angle B equal to the angle A. The angle B is commonly referred to as a camber angle, and as a result of the camber angle B, the rear wheels 70 tilt inward at an upper portion towards the center frame 14 of the vehicle 10. When the upper portion of the rear wheels 70 tilt towards the center frame 14, the camber angle B is called a negative camber angle. Additionally, because the rear wheels 70 are tilted and curved, the portion of the rear wheels 70 that contacts the ground surface 90, which is commonly referred to as a contact patch 91 and is schematically shown in FIG. 5, extends from near the center of the rear wheel 70 to an inside portion of the rear wheel 70.

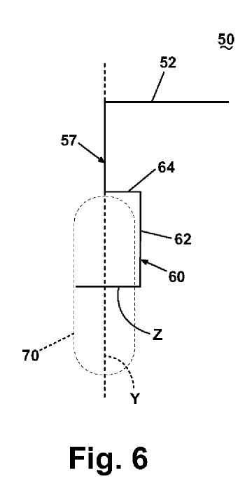

The trailing arm assemblies 60 each comprise a rearwardly extending trailing arm 62 and an inwardly extending linkage arm 64 that is generally perpendicular to the trailing arm 62. The linkage arm 64 terminates at a mounting portion 66 for mounting the trailing arm assembly 60 to the internal rotatable member 58 of the caster arm 57 such that the trailing arm assembly 60 can pivot around the caster arm 57. The trailing arm assemblies 60 couple the curved rear wheels 70 to the caster arms 57. The first and second rear wheels 70A, 70B, each comprise a central hub 72 and are rotatably attached to their respective trailing arms 62 at an end opposite the linkage arms 64 for rotation about an axis Z (FIG. 6) that extends through the hub 72 and is perpendicular to the caster axis defined by the internal rotatable member 58. As best seen in FIG. 2 and shown schematically in FIG. 6, which is a top view of a portion of the rear axle assembly 50, the linkage arm 64 has a length slightly greater than half the width of the rear wheel 70 so that a central radial plane Y of the rear wheel 70 is aligned with the caster arm 57. However, as will be discussed hereinafter, the length of the linkage arm 64 can vary such that the central radial plane Y of the rear wheel 70 is laterally offset from the caster arm 57.

Optionally, the vehicle 10 can comprise a brake, such as a disc brake assembly 80, mounted on the rear axle assembly 50 for locking one of the rear wheels 70 in a desired position. In the present embodiment, the disc brake assembly 80 is mounted to the rear axle assembly 50 to control the orientation of the first rear wheel 70A. When the rider engages the disc brake assembly 80 to lock the orientation of the first rear wheel 70A as the vehicle 10 turns, the vehicle 10 can simulate a skidding motion, as will be described further hereinafter.

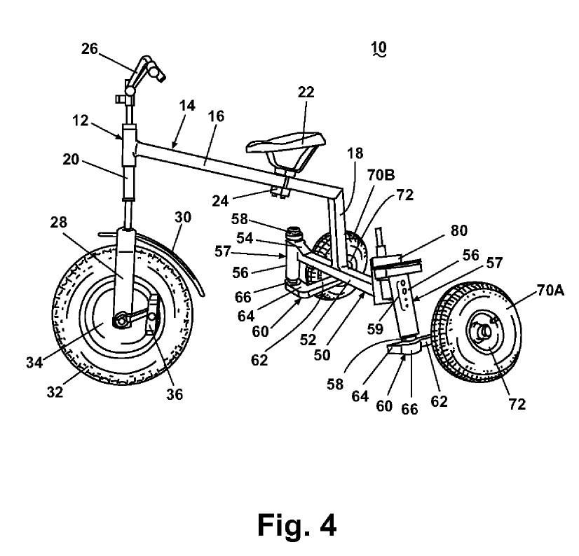

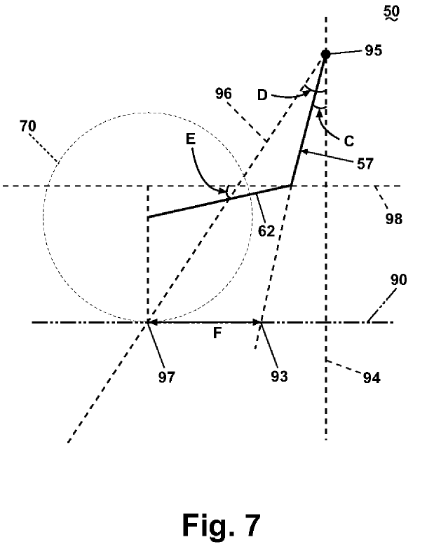

As best viewed in FIGS. 1 and 4 and shown schematically in FIG. 7, which is a side view of a portion of the rear axle assembly 50, the caster arm 57 is inclined rearward relative to the vertical axis 94 at an angle C, which is commonly referred to as a caster angle and is preferably adjustable, such as by the method described previously. When the rear wheel 70 is behind a point 93 at which the caster arm 57, if extended, intersects the ground surface 90, the caster angle is said to be positive. However, because the rear wheels 70 are attached to the caster arms 57 by the trailing arm assemblies 60, the rear wheels 70 are actually angularly offset from the vertical axis 94 by an effective caster angle D greater than the caster angle C. The effective caster angle D is measured as the angle between the vertical axis 94 and an axis 96 defined by a contact point 97 between the rear wheel 70 and the ground surface 90 and an intersection point 95 between the inclined end portion 94 of the rear axle 52 and the caster arms 57. Essentially, the trailing arm 62 spaces the contact point 97 from the intersection point 93 by a distance F that is a function of the length of the trailing arm 62 and a trailing arm angle E between the trailing arm 62 and a horizontal axis 98. Because the trailing arm angle E is fixed, the angle between the caster arm 57 and the trailing arm 62 is also fixed. Increasing the trailing arm angle E increases the height of the rear axle 52 relative to the rear wheels 70 and to the ground surface 90, and increasing the length of the trailing arm 62 increases the distance F. Further, changing the trailing arm angle E or the length of the trailing arm 62 tilts the frame 12 forward or backward about the front wheel 32 and thus, changes the angle at which the steering tube 20 is inclined relative to the vertical axis.

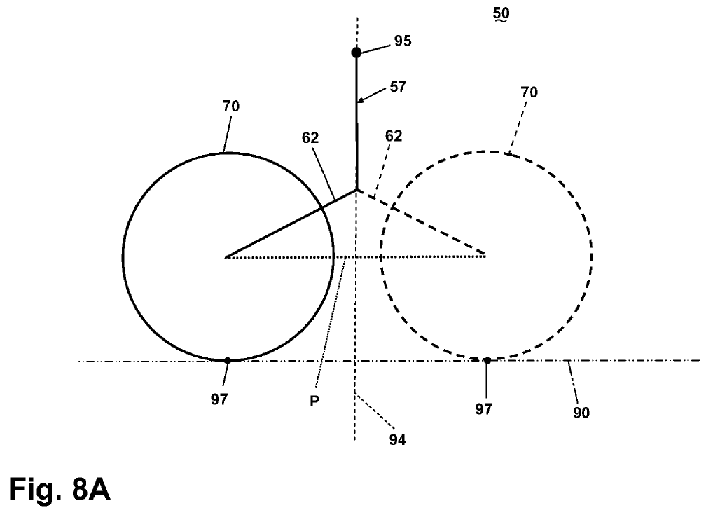

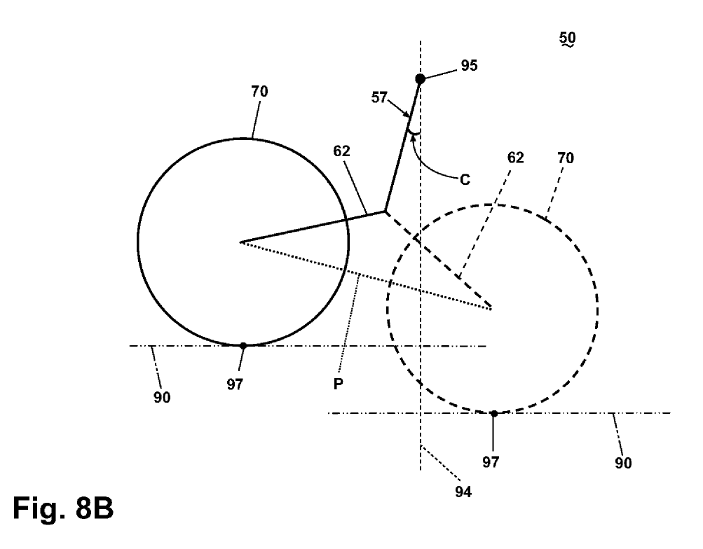

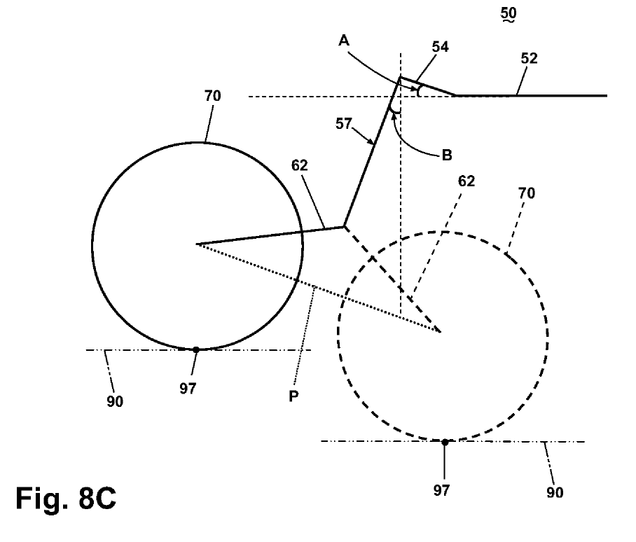

Because the rear wheels 70 are coupled to the internal rotatable members 58 of the caster arms 57 through the mounting portion 66 of the trailing arm assemblies 60, the rear wheels 70 can each pivot about an axis coincident with their respective caster arm 57, also referred to as the caster axis. Essentially, the rear wheel 70 pivots around the caster arm 57 within a plane perpendicular to the caster arm 57. This concept is schematically illustrated in FIGS. 8A-8C, where two positions of the rear wheel 70 as it pivots about its caster arm 57 are shown in solid and dashed lines. If the caster arms 57 were not inclined according to the caster angle C and the camber angle B (i.e., the caster arm 57 is vertical), as shown in FIG. 8A, then a plane P in which the rear wheel 70 pivots about its caster arm 57 is parallel to the ground surface 90, and the frame assembly 12 would remain level as the rear wheels 70 pivot about their respective caster arms 57. However, because the caster arms 57 of the vehicle 10 are inclined according to the caster angle C and the camber angle B, the plane P is also inclined. The effect of the caster angle C on the plane P is shown in FIG. 8B, which is a side view of a portion of the rear axle assembly 50, and the effect of the camber angle B on the plane P is shown in FIG. 8C, which is a rear view of a portion of the rear axle assembly 50. Thus, it can be seen from a combination of FIGS. 8B and 8C, the plane P for each of the rear wheels 70 is tilted in two dimensions relative to the ground surface 90. Further, because the caster arms 57 are inclined at the same camber angle B in opposite directions (i.e., the rear wheels 70 are inclined inwardly toward one another and are not parallel to one another), the tilted planes P are mirror images of one another.

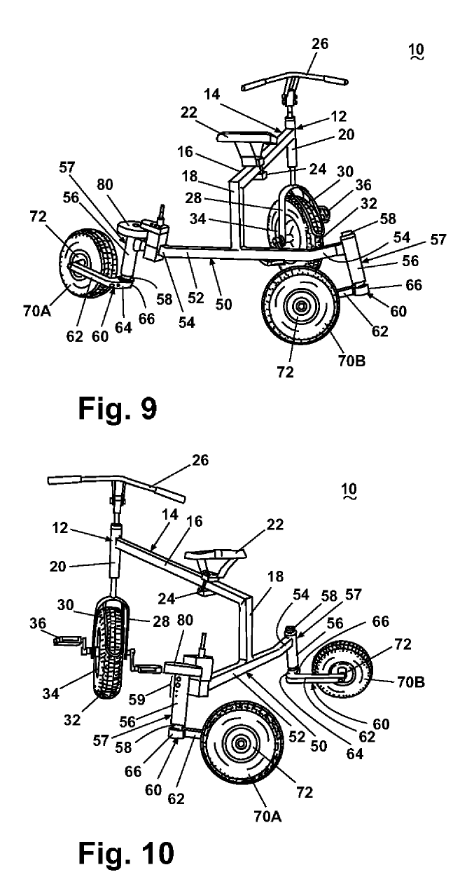

Because it is not physically possible for the ground surface 90 to move while the rear wheels 70 move in their respective tilted planes P, the frame assembly 12 tilts when the rear wheels 70 pivot about the caster arms 57 as the vehicle 10 turns. For example, when the rear wheels 70 pivot to the position shown in FIG. 9, the first rear wheel 70A is positioned at a relatively high point on its tilted plane P, and the second rear wheel 70B is positioned at a relatively low point on its tilted plane P. As a result, the second rear wheel 70B pushes the right side (according to the orientation of FIG. 9) of the rear axle assembly 50 upward, while the left side of the rear axle assembly 50 moves downward to accommodate the position of the first rear wheel 70A. This tilting movement of the rear axle assembly 50 causes the center frame 14 and the seat 22 and thereby the rider on the seat 22 to tilt to the left. Conversely, when the rear wheels pivot to the position shown in FIG. 10, the first rear wheel 70A is positioned at a relatively low point on its tilted plane P, and the second rear wheel 70B is positioned at a relatively high point on its tilted plane P. As a result, the first rear wheel 70A pushes the left side of the rear axle assembly 50 upward, while the right side of the rear axle assembly 50 moves downward to accommodate the position of the second rear wheel 70B. It follows that the center frame 14 and the seat 22 and thereby the rider on the seat 22 to tilt to the right.

During operation of the vehicle 10, the rider rotates the pedal assembly 36 to drive the vehicle forward and simultaneously steers the handle bar assembly 26 to point the front wheel 32 and, thus, the vehicle 10 to a preferred direction. When the rider points the front wheel 32 straight and pedals, the trailing arm assemblies 60 naturally follow the directly behind the caster arms 57, as best viewed in FIGS. 2 and 3, such that the rear wheels 70 follow directly behind the caster arms 57. In this position, the rear wheels 70 are positioned in an equilibrium position wherein the center frame 14 and the rear axle 52 are level with the ground surface 90.

When the rider rotates the handle bar assembly 26 to rotate the wheel fork 28 and point the front wheel 32 towards the left (according to the orientation of FIG. 9), as shown in FIG. 9, the center frame 14 and the rear axle assembly 50 rotate counterclockwise (when viewing the vehicle 10 from above) about the steering tube 20, in accordance with Newton's Third Law, and the trailing arm assemblies 60 and the rear wheels 70 pivot clockwise about the caster arms 57. In particular, the first wheel 70A pivots outward onto a relatively high portion of its plane P, while the second wheel 70B pivots inward onto a relatively low portion of its plane P. When the vehicle 10 turns quickly, the vehicle 10 spins along a counterclockwise arcuate path about a contact point between the front wheel 32 and the ground surface 90 with the rear wheels 70 pointed in the direction of the arcuate path. Further, the center frame 14 and the rear axle 52 tilt downward on the side of the first wheel 70A and upward on the side of the second wheel 70B, as described above. Conversely, when the rider rotates the handle bar assembly 26 to rotate the wheel fork 28 and point the front wheel 32 towards the right, as shown in FIG. 10, the center frame 14 and the rear axle assembly 50 rotate clockwise about the steering tube 20, and the trailing arm assemblies 60 and the rear wheels 70 pivot counterclockwise about the caster arms 57. In particular, the first wheel 70A pivots inward onto a relatively low portion of its plane P, while the second wheel 70B pivots outward onto a relatively high portion of its plane P. When the vehicle 10 turns quickly, the vehicle 10 spins along a clockwise arcuate path about the contact point between the front wheel 32 and the ground surface 90 with the rear wheels 70 pointed in the direction of the arcuate path. Further, the center frame 14 and the rear axle 52 tilt upward on the side of the first wheel 70A and downward on the side of the second wheel 70B, as described above. Hence, when the rider quickly turns the vehicle 10, the vehicle 10 swings along an arcuate path and spins out, which is a motion that many riders enjoy and find amusing. The speed at which the rear wheels 70 pivot about the caster arms 57 depends on the length of the trailing arms 62. As the length of the trailing arms 62 increases, the rear wheels 70 spin around the caster arms 57 at a greater speed, and centrifugal force on the rear wheels 70 increases. Because the rear wheels 70 point in the direction of the arcuate path, there is little or no resistance to the sideways motion of the vehicle 10. As a result, the vehicle 10 is highly efficient and does not throw the rider from the seat 22. Consequently, the vehicle 10 is safe, even when the rider turns the vehicle 10 or spins out at high speeds.

Because the rear wheels 70 are curved and the contact patch 91 of the rear wheels 70 is offset, the rear wheels 70 contribute to the swinging or spinout motion. During the spinout, the center of the rear wheels 70 rotates faster than the inside portion of the rear wheels 70, which is an effect commonly termed camber thrust. Additionally, the rotational speed of the vehicle 10 as it swings depends on the velocity of the vehicle 10 when it begins to turn. As the rider pedals faster, the rotational speed of the vehicle 10 increases as it turns, and the centrifugal force on the vehicle 10 also increases.

The rider can optionally engage the disc brake assembly 80 at any time while turning to prevent the first rear wheel 70A from completely pivoting about the caster arm 57 to the positions shown in FIGS. 9 and 10. As a result, the first rear wheel 70A is not pointed along the arcuate path, and the vehicle 10 moves sideways relative to the first rear wheel 70A to simulate a skidding motion.

When the rider returns the handlebar assembly 26 and, thus, the front wheel 32, to the straight position, the rear wheels 70 return to the position shown in FIGS. 2 and 3. If the rider turns the vehicle 10 to a position where the rear wheels swivel 180 degrees around the caster arms 57 and then returns the handlebar assembly 26 to the straight position and pedals to move forward, the rear wheels 70 immediately pivot back to the straight position shown in FIGS. 2 and 3 under the force of gravity and to return to equilibrium.

The performance of the vehicle 10 while turning can be altered by adjusting various parameters of the rear axle assembly 50. These parameters include: the camber angle B, the caster angle C, the effective caster angle D, the length of the trailing arm 62, and the trailing arm angle E. The effective caster angle D can be changed by altering the length of the trailing arm and/or changing the trailing arm angle E. For example, severity of the tilt can be altered by adjusting the position of the plane P relative to the ground surface 90. This can be accomplished by changing the camber angle B and/or the caster angle C. Further, increasing the length of the trailing arm 62 and/or the trailing arm angle E increases the severity of the tilt. Additionally, as the length of the trailing arm 62 increases, the moment of the rear wheels 70 around the caster arms 57 increases, and, thus, the rear wheels 70 spin around the caster arms 57 at a greater speed. The moment can also be increased by increasing the caster angle C, which effectively increases the distance between the rear wheel 70 and the intersection point 95 of the rear axle 52 and the caster arms 57.

Exemplary values and ranges of values for the camber angle B, the caster angle C, and the length of the trailing arm 62 are provided in Table 1. The actual values for these parameters are dependent on several factors, such as the overall size of the vehicle 10, the size of the rear axle assembly 50, the power source of the vehicle (i.e., pedal or motor), the rider's performance preferences, and the rider's physical characteristics, such as height and weight. These parameters are preferably adjustable so that the rider can configure the vehicle 10 according to a desired performance. The values in Table I are provided for exemplary purposes and are not intended to limit the invention in any manner.

TABLE I
Exemplary Rear Axle Assembly Parameters

| | | Exemplary | Exemplary |
|---|---|---|---|
| | | Range | Range |
| Parameter | Exemplary Value | Minimum | Maximum |
| Camber Angle B | −18° | −10° | −25° |
| Caster Angle C | +12° | +2° | +25° |
| Trailing Arm | 12 in. (for 42 | Highly | Highly |
| Length | in. rear axle) | Dependent on | Dependent on |
| | | the Vehicle | the Vehicle |
| | | Size | Size |

The performance can be affected by changing parameters of the rear axle assembly 50 other than those listed above, such as the length of the caster arm 62 and the length of the rear axle 52, and other parameters of the vehicle, such as the angle at which the steering tube 20 is inclined.

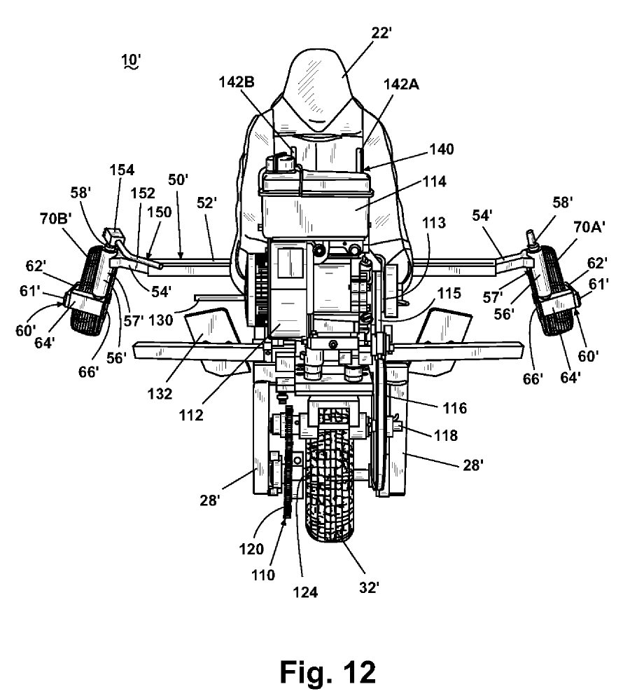

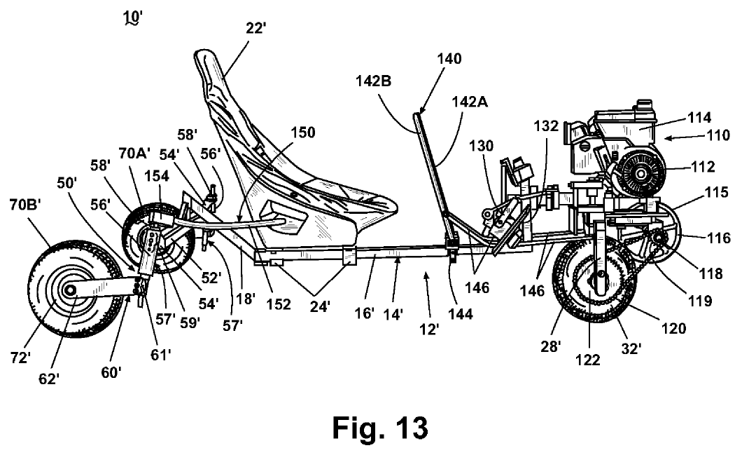

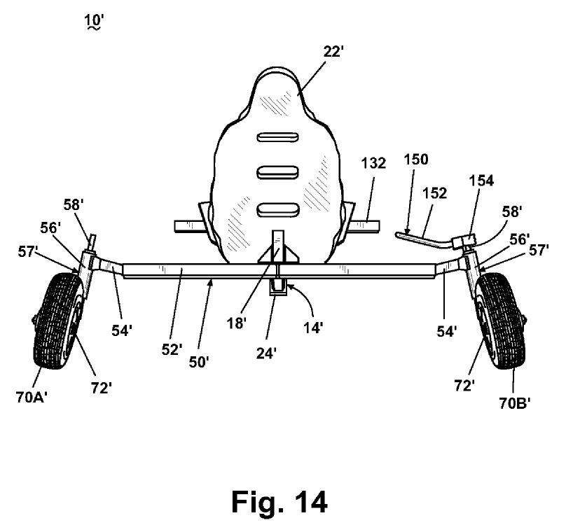

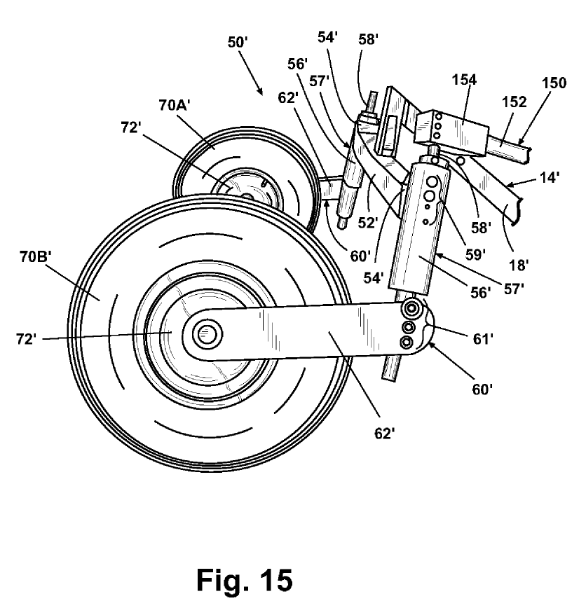

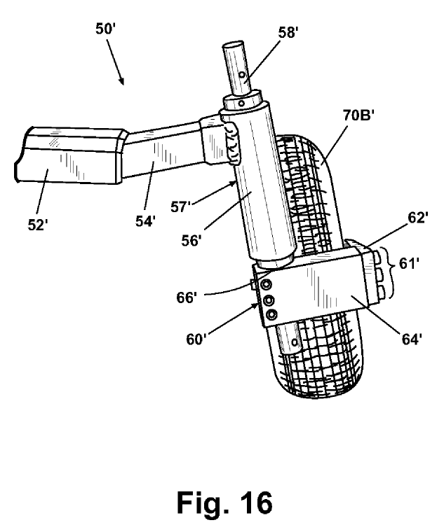

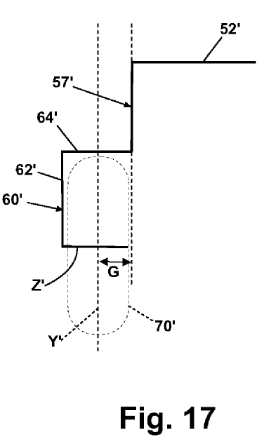

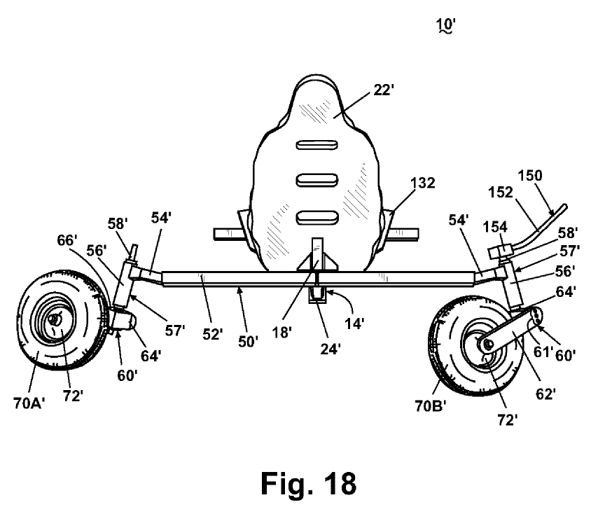

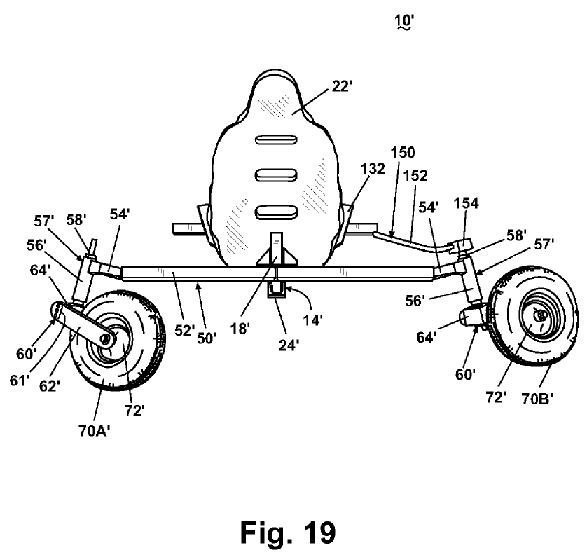

An alternative embodiment of a three wheeled vehicle 10′ according to the invention is illustrated in FIGS. 11-19, where like components are identified with the same reference numeral bearing a prime (′) symbol. Referring particularly to FIGS. 11-14, the vehicle 10′ is a motorized three wheeled vehicle comprising a frame 12′ having a center frame 14′ and a rear axle assembly 50′ mounted to a rear end of the center frame 14′. As best seen in FIG. 1 3, the center frame 14′ is closer to the ground surface 90 than the center frame 14 of the first embodiment vehicle 10 and comprises a generally horizontal center bar 16′ and an upwardly inclined connecting bar 18′ fixed to the center bar 16′. The center bar 16′ slidingly mounts a seat 22′ having adjustable seat brackets 24′ that receive the center bar 16′. A front end of the center bar 16′ supports a footrest assembly 132, a front wheel drive assembly 110, and a front wheel steering assembly 140.

The front wheel drive assembly 110 comprises a motor 112, a fuel tank 114 for storing fuel that powers the motor 112, and a curved front wheel 32′ with a central hub 34′ mounted to a wheel fork 28′ that is preferably angled slightly forward (about ½-degree) relative to a vertical axis (not shown). The motor 112 is operably coupled to the front wheel 32′ through a series of mechanical linkages. The motor 112 includes a rotatable motor shaft 113 in operable communication with a rotatable drive wheel 116 through a belt 115 such that rotation of the motor shaft 113 induces rotation of the drive wheel 116. The drive wheel 116 comprises a generally perpendicular rod 118 that rotates with the drive wheel 116 and is connected to a first chain gear 119 on an opposite side of the front wheel 32′. A chain 120 surrounds a portion of the first chain gear 119 and a portion of a second chain gear 122 so that rotation of the first chain gear 119 induces rotation of the second chain gear 122. The second chain gear 122 is fixed to a generally perpendicular drive shaft 124 that rotates with the second chain gear 122 and extends through the center hub 34′ of the front wheel 32′ to drive the front wheel 32′. The front wheel drive assembly 110 further includes a foot-activated gas pedal 130 conveniently positioned above the footrest assembly 132 and in operative communication with the motor 112 and the fuel tank 114. Hence, when the rider depresses the gas pedal 130, the motor 112 rotates the motor shaft 113 and thereby the drive wheel 116, the rod 118, the first chain gear 119, the second chain gear 122, the drive shaft 124, and the front wheel 32′.

The front wheel steering assembly 140 is operatively coupled to the wheel fork 28′ for controlling the position of the front wheel 32′. The front wheel steering assembly 140 comprises a pair of steering levers 142 (a first steering lever 142A and a second steering lever 142B) adjustably mounted to the center bar 16′ with steering lever brackets 144. The steering levers 142 are preferably positioned a suitable distance in front of the seat 22′ so that the rider can comfortably use his or her arms to pivot the steering levers 142 forwards and backwards. The relative positions of the seat 22′ and the steering levers 142 can be adjusted by sliding the seat brackets 24′ and/or the steering lever bracket 144 along the center bar 16′. A pair of tie rods 146 mechanically connects the steering levers 142 to the wheel fork 28′. Specifically, the first steering lever 142A is connected to one side of the wheel fork 28′ by one of the tie rods 146, and the second steering lever 142B is connected to the other side of the wheel fork 28′ by the other of the tie rods 146. As a result of this configuration, forward and backward pivotal movement of the individual steering levers 142 (i.e., the first steering lever 142A pivots forward when the second steering lever 142B pivots backward and vice-versa) causes the front wheel 32′ to turn from side to side.

Referring generally to FIGS. 11-14 and particularly to FIGS. 15 and 16, the rear axle assembly 50′ of the alternative embodiment vehicle 10′ is substantially identical to that of the vehicle 10, except that a rear wheel steering rod assembly 150 replaces the disc brake assembly 80, and the rear wheels 70′ are laterally offset from the caster arms 57′. The rear wheel steering rod assembly 150 extends from at least one of the caster arms 57′ to near the seat 22′ for manipulation by the rider. The rear wheel steering rod assembly 150 comprises a steering rod 152 mounted to a steering rod block 154 that is adjustably mounted to the internal rotatable member 58′. The steering rod 152 is bent upward so that the rider can easily reach the steering rod 152, and the angular position of the steering rod 152 relative to the steering rod block 154 can be adjusted by rotating the steering rod 152 relative to the steering rod block 154. Further, the vertical position of the steering rod assembly 150 can be adjusted by rotating the steering rod block 154 about the internal rotatable member 58′. The rear wheel steering rod assembly 150 operatively communicates with the internal rotatable member 58′ of the caster arm 57′ to control the position of the rear wheel 70B. In particular, manual rotation of the steering rod 152 induces rotation of the steering rod block 154, which thereby rotates the internal rotatable member 58′ within the caster arm 57′, and rotation of the internal rotatable member 58′ induces pivotal movement of the rear wheel 70′ about the caster arm 57′. In this embodiment, the rear wheel steering rod assembly 150 is mounted on the rear axle assembly 50′ to control movement of the second rear wheel 70B′.

As best viewed in FIG. 16 and shown schematically in FIG. 17, the linkage arm 64′ has a length much greater than half the width of the rear wheel 70′ so that the central radial plane Y′ of the rear wheel 70′ is outwardly offset from the caster arm 57′ by a rear wheel offset G. The rear wheel offset G can be increased by increasing the length of the linkage arm 64′ or by adjusting the connection of the trailing arm 62′ to the central hub 72′. Preferably, the rear wheel offset G is adjustable and depends on the physical parameters of the vehicle 10 and the rider. For example, the rear wheel offset G can be in the range of 0.1 to 2 inches. An exemplary rear wheel offset G for the vehicle 10′ of the present embodiment is about 0.5 inches. Functionally, the rear wheel offset G stabilizes the rear wheels 70′ and prevents the rear wheels 70′ from wobbling during movement of the vehicle 10′. Alternatively, the central radial plane Y′ can be inwardly offset from the caster arm 57′, depending on the configuration of the trailing arm assembly 60′.

Additionally, in this embodiment, the linkage arm 62′ is connected to the trailing arm 64′ by adjustable fasteners 61′ that can be loosened so that the trailing arm angle E′ can be altered and then subsequently tightened to secure the trailing arm 62′ in the desired position. As stated previously, adjustment of the trailing arm angle E′ raises and lowers the rear axle assembly 50′ and also adjusts the angle at which the steering tube 20′ is inclined relative the vertical axis.

The operation of the vehicle 10′ is substantially the same as that of the first embodiment vehicle 10. In the present embodiment, however, the rider powers the vehicle 10′ by depressing the gas pedal 130 towards the footrest assembly 132 with a foot as described previously and steers the vehicle 10′ by pivotally moving the steering levers 142′ forward and backward as described previously. Pulling the first steering lever 142A toward the rider turns the front wheel 32′ to the left, which causes the rear wheels 70′ to pivot clockwise (when viewing the vehicle 10′ from above) about the caster arms 57′, as shown in FIG. 18. Conversely, pulling the second steering lever 142B toward the rider turns the front wheel 32′ to the right, thereby inducing the rear wheels 70′ to pivot counterclockwise about the caster arms 57′, as illustrated in FIG. 19. The movement of the rear axle assembly 50′ and the tilting of the center frame 14 during quick turns are identical to that described above for the first embodiment vehicle 10. Additionally, the rider can optionally control the position of the second rear wheel 70B′ by manually moving the rear wheel steering rod assembly 150. Such movement of the rear wheel steering rod assembly 150 can cause the vehicle 10′ to simulate the skidding motion, if desired. Furthermore, depending on the power rating of the motor 112, the vehicle 10′ is capable of moving much faster than the vehicle 10. Because of the position of the center frame 14′ relative to the ground surface 90′, the vehicle 10′ is stable even at high speeds so that the rider is not displaced from the seat 22′ as the vehicle 10′ turns and tilts.

As stated above, the primary differences between the rear axle assemblies 50 and 50′ are the disc assembly 80/rear wheel steering rod assembly 150 and the rear wheel offset G. It is within the scope of the invention for the first embodiment rear axle assembly 50 to comprise the rear wheel steering rod assembly 150 in place of or in addition to the disc brake assembly 80, and, similarly, the alternative embodiment rear axle assembly 50′ can comprise the disc brake assembly 80 or other brake assembly in place of or in addition to the rear wheel steering rod assembly 150. The disc brake assembly 80 and the rear wheel steering rod assembly 150 can be positioned on the rear axle assembly 50 to control either or both of the first and second rear wheels 70A, 70B. Further, the rear wheels 70 of the first embodiment rear axle assembly 50 can be offset from the caster arms 57 to stabilize the rear wheels 70, and the rear wheels 70′ of the alternative embodiment rear axle assembly 50′ can be aligned with the caster arms 57′.

While the invention has been specifically described in connection with certain specific embodiments thereof, it is to be understood that this is by way of illustration and not of limitation, and the scope of the appended claims should be construed as broadly as the prior art will permit.

What is claimed is:

1. A vehicle comprising:
a frame having a front portion and a rear portion;
a steerable front wheel mounted to the front portion of the frame;
a rear axle transverse to a longitudinal axis of the frame;
a caster arm rotatably mounted at each end of the rear axle for rotation about a caster axis coincident with the caster arm; and
a rear wheel mounted to each caster arm for rotation about an axis perpendicular to the caster axis, the rear wheel adapted to contact the ground surface at a point offset from an intersection of the caster axis with the ground surface;
wherein the caster axis is positioned at a negative camber angle relative to a vertical axis.

2. The vehicle according to claim 1, wherein the camber angle is in a range of about 10 degrees to about 25 degrees.

3. The vehicle according to claim 2, wherein the camber angle is in a range of about 15 degrees to about 20 degrees.

4. The vehicle according to claim 1, wherein the rear wheel has a radial plane passing through the center of the rear wheel, and the radial plane is offset from the caster axis.

5. The vehicle according to claim 4, wherein the radial plane is outwardly offset.

6. The vehicle according to claim 4, wherein the radial plane is offset from the caster axis by a distance in a range of about 0.1 to 2 inches.

7. The vehicle according to claim 6, wherein the radial plane is offset from the caster axis by about 0.5 inches.

8. The vehicle according to claim 1, wherein the caster axis has a positive caster angle with respect to a vertical axis.

9. The vehicle according to claim 8, wherein the caster angle of the caster axis is selectively adjustable.

10. The vehicle according to claim 8, wherein the caster angle is in a range of about 2 degrees to about 25 degrees.

11. The vehicle according to claim 10, wherein the caster angle is in a range of about 10 degrees to about 15 degrees.

12. The vehicle according to claim 1, wherein the rear wheel is mounted to the caster arm through an adjustable connection for raising and lowering the rear portion of the frame with respect to the rear wheel.

13. The vehicle according to claim 1 and further comprising a brake to lock the caster arm in a variety of selected positions with respect to the rear axle.

14. The vehicle according to claim 1 and further comprising a steering rod mounted to one of the caster arms to manually control the position of the caster arm with respect to the rear axle.

15. The vehicle according to claim 1 and further comprising a seat adjustably mounted to the frame.

16. The vehicle according to claim 15 and further comprising a steering mechanism mounted to the frame between the front wheel and the seat.

17. The vehicle according to claim 16, wherein the steering mechanism is adjustably mounted to the frame.

18. The vehicle according to claim 1 and further comprising a motor mounted to the frame and operably connected to the front wheel for driving the front wheel.

19. A vehicle comprising:
a frame having a front portion and a rear portion;
a steerable front wheel mounted to the front portion of the frame;
a rear axle transverse to a longitudinal axis of the frame;
a caster arm rotatably mounted at each end of the rear axle for rotation about a caster axis coincident with the caster arm; and
a rear wheel rotatably mounted to each caster arm for rotation about an axis perpendicular to the caster axis, the rear wheel adapted to contact the ground surface at a point offset from an intersection of the caster axis with the ground surface;
wherein the rear wheel has a radial plane passing through the center of the rear wheel, and the radial plane is offset from the caster axis.

20. The vehicle according to claim 19, wherein the radial plane is outwardly offset.

21. The vehicle according to claim 19, wherein the radial plane is offset from the caster axis by a distance in the range of about 0.1 to 2 inches.

22. The vehicle according to claim 21, wherein the radial plane is offset from the caster axis by about 0.5 inches.

23. A vehicle comprising:
a frame having a front portion and a rear portion;
a steerable front wheel mounted to the front portion of the frame;
a rear axle transverse to a longitudinal axis of the frame;
a caster arm rotatably mounted at each end of the rear axle for rotation about an upright caster axis coincident with the caster arm; and
a rear wheel rotatably mounted to each caster arm for rotation about an axis perpendicular to the caster axis, the rear wheel adapted to contact the ground surface at a point offset from an intersection of the caster axis with the ground surface;
wherein the rear wheel is mounted to the caster arm through an adjustable connection for raising and lowering the rear portion of the frame with respect to the rear wheel.

24. A vehicle comprising:
a frame having a front portion and a rear portion;
a steerable front wheel mounted to the front portion of the frame;
a rear axle transverse to a longitudinal axis of the frame;
a caster arm rotatably mounted at each end of the rear axle for rotation about an upright caster axis coincident with the caster arm;
a rear wheel rotatably mounted to each caster arm for rotation about an axis perpendicular to the caster axis, the rear wheel adapted to contact the ground surface at a point offset from an intersection of the caster axis with the ground surface; and
a steering rod mounted to one of the caster arms to manually control the position of the caster arm with respect to the rear axle.

25. A vehicle comprising:
a frame having a front portion and a rear portion;
a steerable front wheel mounted to the front portion of the frame;
a rear axle transverse to a longitudinal axis of the frame;
a caster arm rotatably mounted at each end of the rear axle for rotation about an upright caster axis coincident with the caster arm; and
a rear wheel rotatably mounted to each caster arm for rotation about an axis perpendicular to the caster axis, the rear wheel adapted to contact the ground surface at a point offset from an intersection of the caster axis with the ground surface;
wherein the caster axis has a positive caster angle with respect to a vertical axis, and the caster angle of the caster axis is selectively adjustable.
